(19) United States
(12) Patent Application Publication
(10) Pub. No.: US 2022/0341369 A1
(43) Pub. Date: Oct. 27, 2022

(54) Closed-loop control method for EFI internal combustion engine on an unmanned aerial vehicle

(71) Applicant: VIETTEL GROUP, Ha Noi City (VN)

(72) Inventors: DUY HUNG NGUYEN, Uong Bi City (VN); HUY HOANG NGUYEN, Ha Noi City (VN); VAN SON BUI, Ha Noi City (VN); NGOC VINH NGO, Ha Noi City (VN)

(73) Assignee: VIETTEL GROUP, Ha Noi City (VN)

(21) Appl. No.: 17/727,471

(22) Filed: Apr. 22, 2022

(30) Foreign Application Priority Data
Apr. 26, 2021 (VN) 1-2021-02314

(51) Int. Cl. F02D 41/14; B64C 39/02; F02D 41/00; F02D 41/38

(52) U.S. Cl. CPC F02D 41/1401; B64C 39/024; F02D 41/0002; F02D 41/1454; F02D 41/38; B64C 2201/044; F02D 2041/1409; F02D 2200/101; F02D 2200/703

(57) ABSTRACT

The present invention provides a closed-loop control method for an electronic fuel injection piston-engine on an unmanned aircraft consisting of the following steps: determination of a set of control coefficients; preliminary determination of fuel injection flow; determination of the injection limit; determination of the actual injectable value; perform fuel injection; the opening of the air intake valve is controlled to ensure that the fuel-air ratio always remains within a specified range. The present invention also provides a method for modeling the operation of an engine at each operating range. In addition, the method of physically simulating the operating conditions according to the pressure ranges of the engine is also proposed. The simulation method to find the control coefficients corresponding to each operating model of the engine is presented, the fuel injection closed-loop control structure is built on a control simulation software.

### FIELD OF THE INVENTION

This invention presents a closed-loop control method for an electronic fuel injection (EFI) piston-engine in an unmanned aircraft. Specifically, the method of the invention can be applied to unmanned aerial vehicles operating over the entire range of ambient pressure with respect to altitude.

### DESCRIPTION OF THE RELATED ART

Piston-powered drones can have a very wide range of altitudes, from near sea level to several kilometers. The air pressure entering the engine can therefore vary over a large range and thus change the operating characteristics of the engine. For engines using electronic fuel injection devices, a suitable control method is required to ensure that the engine operates well with different pressure ranges and rpm.

Patent application CN109973234A presents an electronic fuel injection device for a reciprocating piston engine for an unmanned aircraft. However, it does not describe the method for controlling the engine to operate at different speed and pressure ranges.

Therefore, this patent provides a method to solve the problem of UAV (unmanned aerial vehicle) engine operation in different pressure ranges and rotational speeds.

### SUMMARY OF THE INVENTION

The purpose of this invention is to propose a closed-loop control method for an electronic fuel injection (EFI) piston-engine in an unmanned aircraft that solves the above-mentioned limitations.

This method enables the drone to operate over the full range of rpm and ambient pressure, thereby ensuring stable and efficient operation in all operating conditions.

Specifically, to achieve the above purpose, the method includes:
Step 1: determine the sets of control coefficients according to ambient pressure and speed of rotation; These sets of coefficients are stored in a two-dimensional matrix for reference, where one dimension is the rotational speed and the other is atmospheric pressure, these coefficient sets are calculated based on the determination of engine performance models for each operating pressure range and rpm;
Step 2: preliminary calculation of fuel injection; at this step, the fuel flow rate to be injected is preliminarily calculated by applying the control coefficients just determined to the PID closed-loop control algorithm, where the set point is the desired engine rpm, the feedback value is the current rpm, and the controller output signal is the fuel injection control value;
Step 3: calculate injection limit; this step is to ensure the safe operation of the engine, too much or too little fuel injection can cause the engine to stop working;
Step 4: determine the injection feasible value; at this step, the actual feasible value is equal to the pre-calculated value if it is within the injection limit; conversely, if the preliminary calculated value is outside the injection limit, the actual injection value is equal to the injection limit closest to the expected injection value;
Step 5: perform fuel injection and ignition; at this step, fuel is injected into the engine with the amount corresponding to the value just determined in step 4, the ignition control time is determined based on the camshaft position sensor;
Step 6: control the engine air intake valve; The purpose of this step is to ensure that the gas and fuel ratio is kept within the allowable range to maintain the engine's operation, the control of the air intake valve is implemented by a closed-loop controller;

According to an embodiment of the present invention, a method of modeling engine operation at each operating range is performed based on an experimental method with the following steps: applying a special signal pulse to control fuel injection so that the engine operates at different ranges of rpm and ambient pressure, and then data is collected to build models of performance. The pulses supplied to the engine are designed with special frequencies and amplitudes so that it can make the engine present the response of the process of increasing and decreasing rotational speed. The construction of engine operation model from data is done by model recognition tools, the model type can be linear or nonlinear.

According to an embodiment of the present invention, a method of physically simulating operating conditions over the pressure ranges of the engine is performed by supplying air to the engine from a system capable of supplying air with static pressure levels lower than the atmospheric pressure at sea level, in order to simulate the pressure according to the flight altitudes of the aircraft.

According to an embodiment of the invention, the simulation method to find the control coefficients corresponding to each operating model of the engine, the fuel injection closed-loop control structure is built on a control simulation software, including engine models, controller, set point, feedback signal; The control coefficients are found by a simulation tool that fine-tunes the system response according to the response time and transient behavior.

### BRIEF DESCRIPTION OF THE DRAWINGS

FIG. 1 is a connection diagram of two-stroke engine electronic fuel injection control system components for an unmanned aircraft.

### DETAILED DESCRIPTION OF THE PREFERRED EMBODIMENTS

The invention detailed below is based on accompanying drawings, which are intended to illustrate variations of the present invention without limiting the scope of the patent.

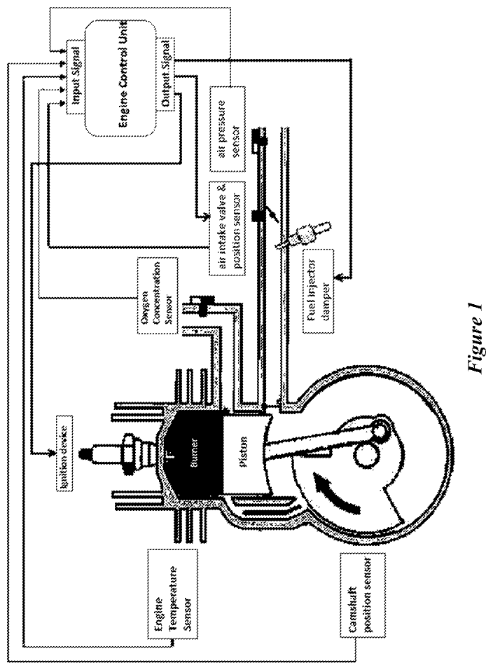

FIG. 1 describes the connection diagram of components in the electronic fuel injection control system of piston engine for UAV. The air pressure sensor helps to determine the level of air pressure entering the engine so that the ECU selects the appropriate control coefficients in step 1 of the control method proposed by this invention. The temperature sensor and camshaft position sensor indicate the instantaneous operating status of the engine. The signal from the camshaft position sensor helps determine the ignition timing, and also indicates the engine's rotational speed. The oxygen concentration sensor reflects the concentration of oxygen in the exhaust gas, thereby helping the ECU control the ratio of fuel and air entering the engine through controlling the air intake valve and fuel injection.

According to the first aspect, the present invention provides a closed-loop control method for an electronic fuel injection piston-engine on an unmanned aircraft consisting of the following steps:
Step 1: determination of the set of control factors according to the pressure and engine rotational speed;
Step 2: preliminary calculation of fuel injection flow;
Step 3: calculation of injection limit;
Step 4: determination of the actual injection value;
Step 5: perform fuel injection and ignition control;
Step 6: control the engine air intake valve;

The content of the steps of the specific control method is as follows:

Step 1: determine the set of control coefficients according to the pressure and engine rotational speed;

At this step, the sets of control coefficients for pressure and speed are stored in a two-dimensional matrix for reference, where one dimension is the rotational speed and the other is atmospheric pressure. These sets of coefficients are determined based on performance models of the engine according to each pressure range and rotational speed range. Determination of engine performance models can be done based on an empirical approach.

Step 2: preliminary determination of fuel injection flow;

At this step, the preliminary determination of the fuel injection flow is implemented by applying the control coefficients determined in step 1 to the PID closed-loop control algorithm, where the set point is the desired rotational speed, the feedback value is the current rpm, and the controller output signal is the fuel injection control value, i.e. the expected fuel injection flow rate.

Step 3: determine spray limit;

The purpose of this step is to ensure safe engine operation, too much or too little fuel injection can cause the engine to stop; The upper and lower limits of fuel injection are set based on the physical characteristics of the engine, in order to ensure the continuous operation of the engine.

Step 4: determine the feasible injection value;

At this step, the actual feasible value is equal to the pre-calculated value if it is within the injection limit; conversely, if the preliminary calculated value is outside the injection limit, the actual injection value is equal to the injection limit closest to the expected injection value;

Step 5: perform fuel injection and ignition;

Fuel is injected into the engine with the amount corresponding to the value just determined in step 4, the ignition control time is determined based on the camshaft position sensor;

Step 6: control the air intake valve;

The purpose of this step is to ensure that the gas and fuel ratio is kept within the allowable range to maintain the engine's operation, air intake valve is controlled by a closed-loop controller in which the engine control system has an oxygen sensor that measures the oxygen concentration at the exhaust gas outlet, the controller will control the air intake valve so that the output oxygen concentration meets the set value.

As a further aspect, the present invention provides a closed-loop control method for a piston-engine electronic fuel injection in an unmanned aircraft where:
the method of building engine operation models at each operating range is implemented based on the experimental method with the following steps: providing special control signals to control fuel injection to the engine operating at different operating ranges of rpm and ambient pressure, and then collect data to build models of behavior. The special control signals are designed with appropriate frequencies and amplitudes such that they are capable of making the engine show the responses of the process of increasing and decreasing rotational speed. The construction of engine operation model from data is done by model recognition tools, the model type can be linear or nonlinear.

As a further aspect, the present invention provides a closed-loop control method for a piston-engine electronic fuel injection in an unmanned aircraft where:
a method of representing physical operating conditions over the pressure ranges of the engine is achieved by supplying air at the engine inlet from a system capable of supplying air with static pressure levels lower than atmospheric pressure at sea level. This method helps simulate the pressure according to the flight altitudes of the aircraft. The engine is controlled to start and operate at different rpm ranges while the air from supply system enters the engine at different pressure levels. Data is collected for analysis and construction of operating models.

As a further aspect, the present invention provides a closed-loop control method for an electronic fuel injection piston-engine in an unmanned aircraft comprising:
simulation method to find control coefficients corresponding to each operating model of the engine. The fuel injection closed-loop control structure is built on a control simulation software, including the engine models, the controller, the set point, the feedback signal; The control coefficients are found by a simulation tool that fine-tunes the system response according to the response time and transient behavior. The sets of control coefficients corresponding to each operating model, after being discovered, will be embedded in a two-dimensional reference matrix, in which one dimension corresponds to the variation of rotational speed and the other corresponds to the change in operating pressure.

This invention describes a method for closed-loop control of a two-stroke piston engine electronic fuel injection for an unmanned aerial vehicle at the operational stage after starting, so that the engine follows the set point rpm value. The closed-loop control method of air intake valve is assumed to be known in advance and is not further analyzed in this present invention.

A special feature of this patent is that the control coefficients of the EFI controller are designed to adapt to the changes of the engine's operating conditions, including rpm and operating pressure. The present invention provides a physical test method that simulates engine operation at different altitudes, through the use of an air supply system capable of supplying air with static pressure levels lower than atmospheric pressure at sea level.

The method of modeling the operating characteristics of the engine is performed in the following order: at the ranges of pressure and rotational speed to be modeled, the fuel is controlled to be injected for the engine to operate according to a special pulse signal designed to cause the engine to exhibit performance characteristics. Then experiment data is collected, and is used to build engine response models.

To find the control coefficients, the engine control system structure is set up on the simulation software, then the control coefficients are found by a tuning tool according to response time and transient behavior. These coefficients are then embedded in the electronic fuel injection controller to control the fuel injection. Fuel injection limits are also calculated to ensure continuous engine performance.

The opening of the air intake valve is controlled to ensure that the fuel-air ratio always remains within a specified range, based on feedback from the exhaust gas oxygen sensor. The ignition timing in the engine is determined based on the camshaft position sensor.

1. Closed-loop control method for an electronic fuel injection piston-engine on an unmanned aircraft includes the following steps:
define a set of control coefficients according to pressure and speed of rotation, these sets of coefficients are stored in a two-dimensional matrix for reference, where one dimension is a rotational speed and the other is an ambient pressure, these sets of coefficients are calculated based on the determination of engine performance models for each range of operating pressure and rpm;
Preliminary calculation of fuel injection flow through applying the control coefficients just determined to a PID closed-loop control algorithm, in which a set point is the desired engine rpm, a feedback value is a current rotational speed, and a controller output signal is a fuel injection control value;
calculate an injection limit to ensure the safe operation of the electronic fuel injection piston-engine;
determine an actual injectable value by an expected injection value if it is within the injection limit; conversely, if the expected injection value is outside the injection limit, the actual injection value is equal to the injection limit closest to the expected injection value;
perform fuel injection and control ignition of the fuel injected into the electronic fuel injection piston-engine through the control signal just calculated to open a fuel injector damper, an ignition control time is determined based on a camshaft position sensor;
calculate and control an air intake valve to ensure that a gas and fuel ratio stays stable within an allowable range to maintain the electronic fuel injection piston-engine's operation, the control of the air intake valve is implemented by a closed loop controller.

2. The closed-loop control method for the electronic fuel injection piston-engine on an unmanned aircraft according to claim 1, in which:
a method of modeling the engine's operation at each operating range is implemented based on a experimental method with the following steps: providing a special pulse signal to control fuel injection for the engine to operate at different ranges of rpm and ambient pressure, and then data is collected to build models of performance; the special pulse signals supplied to the engine are designed with special frequencies and amplitudes so as to make the electronic fuel injection piston-engine present a response of a process of increasing and decreasing rotational speed; the construction of engine operation model from data is done by model recognition tools, the model type can be linear or nonlinear.

3. The closed-loop control method for the electronic fuel injection piston-engine on an unmanned aircraft according to claim 2, in which:
method of physically simulating operating conditions over pressure ranges of the engine is performed by supplying air to the electronic fuel injection piston-engine from a system capable of supplying air with static pressure levels lower than an atmospheric pressure at sea level, in order to simulate the pressure according to flight altitudes of the aircraft.

4. The closed-loop control method for the electronic fuel injection piston-engine on an unmanned aircraft according to claim 1, in which:
simulation method to find control coefficients corresponding to each operating model of the electronic fuel injection piston-engine, the fuel injection closed-loop control structure is built on a control simulation software, including engine model components, controller, set point, feedback signal; The control coefficients are found by a simulation tool that fine-tunes the system response according to the response time and transient behavior.

5. The closed-loop control method for the electronic fuel injection piston-engine on an unmanned aircraft according to claim 2, in which:
simulation method to find control coefficients corresponding to each operating model of the electronic fuel injection piston-engine, the fuel injection closed-loop control structure is built on a control simulation software, including engine model components, controller, set point, feedback signal; The control coefficients are found by a simulation tool that fine-tunes the system response according to the response time and transient behavior.
